(19) United States
(12) Patent Application Publication
(10) Pub. No.: US 2025/0210735 A1
(43) Pub. Date: Jun. 26, 2025

(54) INTELLIGENT CELL, BATTERY MODULE AND BATTERY PACK

(71) Applicant: Yijun ZHAO, Shanghai (CN)

(72) Inventor: Yijun ZHAO, Shanghai (CN)

(21) Appl. No.: 18/852,050

(22) PCT Filed: Mar. 29, 2023
(86) PCT No.: PCT/CN2023/084558

§ 371 Date: Sep. 27, 2024

(30) Foreign Application Priority Data
Mar. 31, 2022 (CN) 202210329943.3
Oct. 13, 2022 (CN) 202211253281.2

(51) Int. Cl. H01M 10/42; H01M 10/48; H02J 7/00

(52) U.S. Cl. CPC H01M 10/4257; H01M 10/482; H02J 7/00032; H02J 7/007; H01M 2010/4278

(57) ABSTRACT

There are provided an intelligent cell, a battery module (100) containing the intelligent cell, and a battery pack (600) containing the battery module (100). The intelligent cell contains a cell unit (110), an internal switch circuit (120) and a local controller (130), wherein the internal switch circuit (120) is coupled to a positive electrode or a negative electrode of the cell unit (110). The local controller (130) comprises an internal detection unit (131), a communication unit (132) and a processing unit (133), wherein the internal detection unit (131) is configured to detect a state parameter of the cell unit (110), and the state parameter comprises at least one of an input voltage, an output voltage, and a temperature. The communication unit (132) is configured to establish a communication connection with a device external to the intelligent cell, and the processing unit (133) is coupled to the internal switch circuit (120), the internal detection unit (131) and the communication unit (132), and the processing unit (133) is configured to control on-off of the internal switch circuit (120) based on the state parameter or in response to a control command received by the communication unit (132).

### TECHNICAL FIELD

The present application relates to battery management technology and, in particular, to an intelligent cell, a battery module comprising the intelligent cell and a battery pack comprising the battery module.

### BACKGROUND

A cell is a basic electrical energy storage unit in a power battery. Multiple cells may be packaged in a housing frame to form a battery module, and the cells in the module generate energy input (when charging) and energy output (when discharging) with the outside through a unified boundary. A battery pack is formed when multiple battery modules are controlled or managed by a common battery management system and thermal management system.

By increasing energy density, the amount of electrical energy stored in the battery may be increased, thereby enabling electric vehicles to have a longer range. In addition, the quality of the cells also determines the service life of the battery, and when one cell fails, it may cause damage to the entire battery pack.

### SUMMARY

In accordance with an aspect of the present application, there is provided an intelligent cell comprising:
a cell unit;
an internal switch circuit coupled to a positive electrode or negative electrode of the cell unit; and
a local controller comprising:
an internal detection unit configured to detect a state parameter of the cell unit, the state parameter comprising at least one of an input voltage, an output voltage, and a temperature;
a communication unit configured to establish a communication connection with a device external to the intelligent cell; and
a processing unit coupled to the internal switch circuit, the internal detection unit and the communication unit, configured to control on-off of the internal switch circuit based on the state parameter or in response to a control command received by the communication unit.

Optionally, in the intelligent cell, the internal switch circuit comprises a single MOS tube, and the processing unit places the internal switch circuit in an on-state or an off-state by controlling on-off of the single MOS tube.

In addition to one or more of the above features, in the intelligent cell, there is also included a discharge circuit coupled to the cell unit, and the processing unit is further configured to place the discharge circuit in an enabled-state or a disabled-state based on the state parameter or in response to a control command received by the communication unit.

Optionally, in the intelligent cell, the communication unit is a wireless signal transceiver or a bus signal transceiver.

Optionally, in the intelligent cell, the processing unit is further configured to report, via the communication unit, to the device external to the intelligent cell, at least one of the following items: an occurrence of a trigger event of a set type, the input voltage, the output voltage and the temperature of the cell unit as detected.

Optionally, in the intelligent cell, the processing unit is configured to control the on-off of the internal switch circuit or to place the discharge circuit in the enabled-state or the disabled-state based on the state parameter by responding to the trigger event of the set type.

Optionally, in the intelligent cell, the trigger event of the set type comprises one or more of: 1a) at least one of the state parameter exceeding a corresponding preset range; 1b) a rate of change of at least one of the state parameter exceeding a corresponding threshold; 1c) at least one of the state parameter returning to the preset range from outside the corresponding preset range; 1d) a rate of change of at least one of the state parameter dropping from exceeding the corresponding threshold to below the threshold.

Optionally, in the intelligent cell, the local controller is further configured to modify settings regarding the preset range and the threshold based on a configuration command from the device external to the intelligent cell.

In accordance with another aspect of the present application, there is provided a battery module comprising:
a main controller;
a plurality of intelligent cells, each intelligent cell comprising:
a cell unit;
an internal switch circuit coupled to a positive electrode or negative electrode of the cell unit; and
a local controller comprising:
   an internal detection unit configured to detect a first state parameter of the cell unit, the first state parameter comprising at least one of an input voltage, an output voltage, and a temperature of the cell unit;
   a first communication unit configured to establish a communication connection with the main controller or a device external to the battery module; and
   a processing unit coupled to the internal switch circuit, the internal detection unit and the first communication unit, configured to control on-off of the internal switch circuit based on the first state parameter or in response to a control command received by the first communication unit;
a main switch circuit coupled in series with the cell units of the plurality of intelligent cells;
wherein the main controller comprising:
   a detection unit configured to detect a second state parameter of the cell unit in each intelligent cell, the second state parameter comprising at least one of an input voltage, an output voltage, an input current, an output current, and a temperature of the cell unit;
   a second communication unit configured to establish a communication connection with the first communication unit in each intelligent cell;
   a main processing unit coupled to the detection unit, the second communication unit and the main switch circuit, configured to: i) generate the control command or control on-off of the main switch circuit based on the first state parameter of the cell unit reported in each intelligent cell; and ii) generate the control command or control on-off of the main switch circuit based on the second state parameter of the cell unit in each intelligent cell.

Optionally, in the battery module, in each intelligent cell, the internal switch circuit comprises a single MOS tube connected in series within a loop in which the cell unit is located, and the processing unit places the internal switch circuit in an on-state or an off-state by controlling on-off of the single MOS tube.

Optionally, in the battery module, the main switch circuit comprises a first MOS tube and a second MOS tube connected in series, the main controller places the main switch circuit in an on-state or an off-state by controlling on-off of the first MOS tube and the second MOS tube.

Optionally, in the battery module, each intelligent cell further comprises a discharge circuit coupled to the cell unit, and the processing unit is further configured to place the discharge circuit in an enabled-state or a disabled-state based on the first state parameter or in response to a control command received by the communication unit.

Optionally, in the battery module, the first communication unit and the second communication unit are wireless signal transceivers or bus signal transceivers.

Optionally, in the battery module, in each intelligent cell, the processing unit is further configured to report, via the first communication unit, to the main controller or the device external to the battery module, at least one of the following items: an occurrence of a trigger event of a first set type, the input voltage, the output voltage and the temperature of the cell unit as detected.

Optionally, in the battery module, in each intelligent cell, the processing unit is configured to control the on-off of the internal switch circuit or to place the discharge circuit in the enabled-state or the disabled-state based on the first state parameter by responding to the trigger event of the first set type.

Optionally, in the battery module, the trigger event of the first set type comprises one or more of: 1a) at least one of the first state parameter exceeding a corresponding preset range; 1b) a rate of change of at least one of the first state parameter exceeding a corresponding threshold; 1c) at least one of the first state parameter returning to the preset range from outside the corresponding preset range; 1d) a rate of change of at least one of the first state parameter dropping from exceeding the corresponding threshold to below the threshold.

Optionally, in the battery module, in each intelligent cell, the local controller is further configured to modify settings regarding the preset range and the threshold based on a configuration command from the main controller or the device external to the battery module.

Optionally, in the battery module, the main processing unit is configured to generate the control command or control the on-off of the main switch circuit based on the second state parameter by responding to the trigger event of a second set type.

Optionally, in the battery module, the trigger event of the second set type comprises one or more of: 2a) at least one of the second state parameter exceeding a corresponding preset range; 2b) a rate of change of at least one of the second state parameter exceeding a corresponding threshold; 2c) at least one of the second state parameter returning to the preset range from outside the corresponding preset range; 2d) a rate of change of at least one of the second state parameter dropping from exceeding the corresponding threshold to below the threshold.

In accordance with another aspect of the present application, there is provided a battery pack comprising:
a battery module as described above;
at least one master controller communicatively coupled to a main controller in each battery module.

Optionally, communication between the master controller and the main controller of the battery module, and communication among the main controllers of the battery modules are established via a communication bus.

Optionally, communication between the master controller and the main controller of the battery module, and communication among the main controllers of the battery modules are established via a wireless channel.

### DESCRIPTION OF THE DRAWINGS

The above and/or other aspects and advantages of the present application will be clearer and more easily understood from the following description of various aspects in conjunction with the accompanying drawings, in which the same or similar units are denoted by the same reference numerals. The accompanying drawings include:

FIG. 1 is a schematic block diagram of an intelligent cell in accordance with some embodiments of the present application.

FIG. 2 is a schematic block diagram of a local controller in accordance with some other embodiments of the present application.

FIG. 3 is a schematic circuit diagram of a discharge circuit in accordance with some other embodiments of the present application.

FIG. 4 is a schematic block diagram of a battery module in accordance with some other embodiments of the present application.

FIG. 5 is a schematic block diagram of a main controller in accordance with some other embodiments of the present application.

FIG. 6 is a schematic diagram of a battery pack in accordance with some other embodiments of the present application.

### DETAILED DESCRIPTION

The following DETAILED DESCRIPTION are merely exemplary in nature and are not intended to limit the present application or the applications and uses hereof. Many specific details are set forth in the following description of DETAILED DESCRIPTION of the present application in order to provide a deeper understanding of the present application. However, one of ordinary skill in the art will still be able to practice the present application without providing these specific details. In some examples, features that are well known have been omitted to avoid complicating the description.

In this specification, terms such as “comprising” and “including” mean that in addition to units and steps that are directly and clearly stated in the specification and claims, the technical solution of the present application does not exclude the presence of other units and steps that are not directly or clearly stated in the specification and claims.

Unless otherwise specified, terms such as “first” and “second” do not indicate the order of the units in time, space, size, etc., but are used only for the purpose of distinguishing the units.

### Intelligent Cell

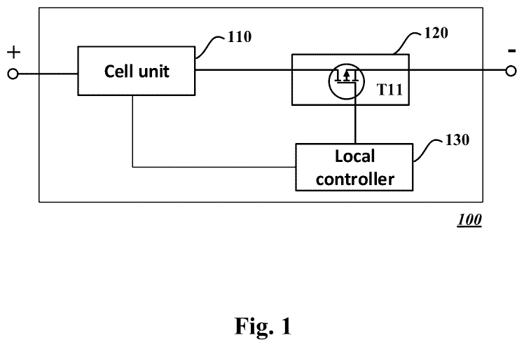

FIG. 1 is a schematic block diagram of an intelligent cell in accordance with some embodiments of the present application. It should be noted that in this specification, the terms “intelligent cell” and “cell module” are used interchangeably.

An intelligent cell or cell module 100 shown in FIG. 1 includes a single cell unit or battery cell 110, an internal switch circuit 120, and a local controller 130.

The cell unit 110, which serves as a basic energy storage unit in a battery pack, may have various structures. In an exemplary example, the cell unit includes a positive electrode, a negative electrode, a diaphragm, an electrolyte or solid electrolyte, and a housing that houses each of the above components and materials. In FIG. 1, the internal switch circuit 120 is coupled to the negative electrode of the cell unit 110, but this is merely exemplary and the internal switch circuit 120 may also be coupled to the positive electrode of the cell unit 110. The local controller 130 may, based on a state of the cell unit 110, control on-off of a loop in which the cell unit 110 is located by controlling on-off of the internal switch circuit 120, so as to realize charging and discharging control of the cell unit as well as the connection control of the cell unit with a device external to the intelligent cell.

In some embodiments, the internal switch circuit may include a single MOS tube as a switch element. Exemplarily, as shown in FIG. 1, a source (drain) of the single MOS tube T11 is coupled to the negative electrode of the cell unit 110, and a drain (source) is coupled to the negative electrode of the intelligent cell, and the local controller 130 places the internal switch circuit in an on-state or an off-state by controlling a gate voltage of the MOS tube. The use of the single MOS tube in the intelligent cell to realize the function of the internal switch circuit can simplify the circuit structure and control logic. It should be noted that the MOS tube T11 is not limited to the P-channel enhancement type MOS tube shown in FIG. 1, and the use of other types of MOS tubes is also feasible, such as the P-channel depletion type, the N-channel enhancement type, and the N-channel depletion type.

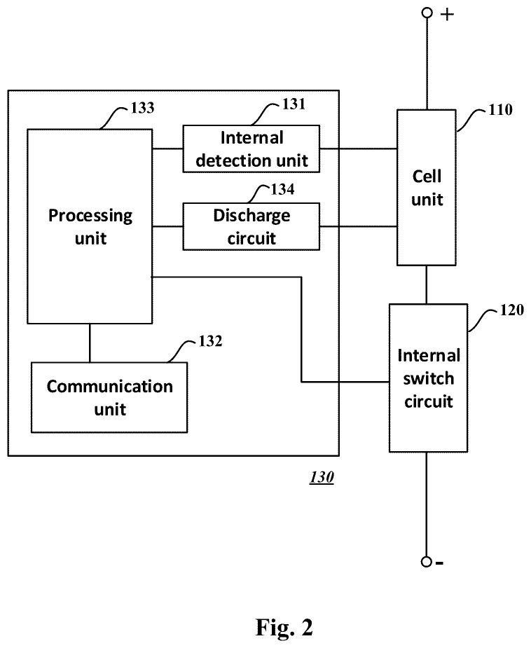

FIG. 2 is a schematic block diagram of a local controller in accordance with some other embodiments of the present application, which may be used as a local controller in the intelligent cell shown in FIG. 1.

In the local controller shown in FIG. 2, each box corresponds to a corresponding logic function module. It is noted that in specific implementations, various ways may be used to realize the logic function of each module. For example, one or more logic function modules may be implemented by a single hardware circuit, or one or more logic function modules may be implemented by multiple hardware circuits in concert. In some embodiments, the hardware circuit may be implemented in the form of a die, and optionally, multiple hardware circuits in the form of the die are packaged and combined together to form a Chiplet.

Referring to FIG. 2, the local controller 130 includes an internal detection unit 131, a communication unit 132, and a processing unit 133. Optionally, the local controller 130 also includes a discharge circuit 134. The above components will be further described below.

The internal detection unit 131 is configured to detect a first state parameter of the cell unit 110. The first state parameter described herein may be used to characterize one or more operational states (e.g., an electrical state and a thermal state, etc.) of the cell unit. In some embodiments, the first state parameter includes one or more of the following items: an input voltage of the cell unit, an output voltage of the cell unit, and a temperature of the cell unit, etc. Exemplarily, the input voltage and the output voltage may be obtained by utilizing a voltage sampling circuit connected to a positive or negative electrode of the cell unit, and the temperature may be obtained by utilizing a temperature sensor disposed within or near the cell unit.

The communication unit 132 is a communication interface of the intelligent cell or the local controller, which is configured to establish a wireless or wired communication connection with devices external to the intelligent cell (e.g., a main controller of a battery module to be described below, and an information processing device such as a smartphone, a laptop, a tablet, and a desktop computer, among others). Optionally, the communication unit 132 may be a wireless signal transceiver (e.g., a Bluetooth communication device or a near field communication device). Alternatively, the communication unit may be a bus signal transceiver (e.g., a single bus signal transceiver). In some embodiments, near field communication technology may be utilized to enable communication between the local controller and a device external to the intelligent cell. For example, the wireless signal transceiver may be an initiating device (also referred to as a master device) or a target device (also referred to as a slave device) operating in an active mode in which it actively generates a radio frequency field to achieve communication with external devices. The wireless signal transceiver may also be a target device operating in a passive mode, in which it does not generate the radio frequency field but passively receives the radio frequency field generated by the master device to achieve communication with the external devices.

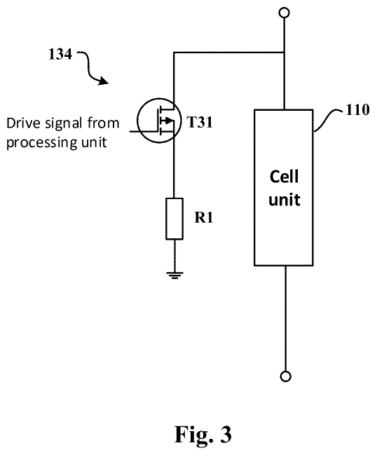

Under the control of the processing unit 133, the discharge circuit 134 may be in an enabled-state or a disabled-state. In the enabled-state, the current flowing into or out of the cell unit 110 is shunted by the discharge circuit 134, thereby reducing the charging voltage on the cell unit 110; in the disabled-state, the shunt function of the discharge circuit 134 is disabled. Exemplarily, as shown in FIG. 3, the discharge circuit 134 includes a shunt resistor R1 and a switch element T31 (e.g., a MOS tube) connected in series, wherein a drain or a source of the switch element T31 is connected to the positive or negative electrode of the cell unit 110, and the shunt resistor R1 is grounded. The processing unit 133 puts the discharge circuit 134 into the enabled-state or disabled-state by controlling the gate voltage of the MOS tube T31.

The processing unit 133 is coupled to the internal switch circuit 120, the internal detection unit 131, the communication unit 132, and the discharge circuit 134, which is configured to perform various operations. In some embodiments, the operations include, for example, obtaining the first state parameter of the cell unit 110 from the internal detection unit 131 and controlling on-off of the internal switch circuit 120 (e.g., by controlling a gate voltage of the MOS tube T11) or placing the discharge circuit 134 in the enabled-state or disabled-state (e.g., by controlling a gate voltage of the MOS tube T31) based on the first state parameter; controlling on-off of the internal switch circuit 120 or placing the discharge circuit 134 in the enabled-state or disabled-state in response to a control command received by the communication unit 132.

In particular, the processing unit 133 may realize the above operations by responding to a trigger event of a set type associated with a change in the first state parameter. That is, when the trigger event of the set type occurs, the internal switch circuit 120 is placed in an on-state or an off-state, or the discharge circuit 134 is placed in the enabled-state or the disabled-state. In some embodiments, the trigger event of the set type may include one or more of the following items:
1a) at least one of the first state parameter exceeds a corresponding preset range. For example, assuming that a temperature preset range is from −5C0 to 50C0 Celsius, a trigger event of type 1a) is determined to occur when the current temperature of the cell unit exceeds this preset range.
1b) a rate of change of at least one of the first state parameter exceeds a corresponding threshold. For example, assuming that a threshold of a rate of change of the input voltage is set to 5V/second, a trigger event of type 1b) is determined to occur when the rate of change of the input voltage of the cell unit exceeds the threshold.
1c) at least one of the first state parameter returns to the preset range from outside the corresponding preset range. For example, assuming that a temperature preset range is from −5C0 to 50C0 Celsius, a trigger event of type 1c) is determined to occur when the current temperature of the cell unit changes from 51C0 at a previous moment to the current 49C0. It should be noted that for the same type of state parameter, the preset ranges of the trigger condition for type 1a) and the trigger condition for type 1c) may or may not be the same. For example, the upper limit of the preset range for type 1a) may be higher than the upper limit of the preset range for type 1c), and the lower limit of the preset range for type 1a) may be lower than the lower limit of the preset range for type 1c).

1d) a rate of change of at least one of the first state parameter drops from exceeding the corresponding threshold to below the threshold. For example, if a threshold of a rate of change of the input voltage is still set to 5V/second as mentioned above, a trigger event of type 1d) is determined to occur when the rate of change of the input voltage of the cell unit drops from 5.5V/second to 5V/second. It should be noted that for the same type of state parameter, the thresholds of the rate of change for the trigger events of types 1b) and 1d) may or may not be the same.

In the above-described types 1a) and 1c), the preset range of the state parameter may be used to judge a trending change in the state of the cell unit, i.e., whether the trending change will cause the cell unit to go out of the normal operating range or return to the normal operating range. On the other hand, in the above-described types 1b) and 1d), the threshold of the rate of change of the state parameter may be used to judge a transient fluctuation of the state of the cell unit, i.e., whether the transient fluctuation will cause the cell unit to go out of the normal operating range (e.g., a transient and rapid rise in voltage and current) or whether the transient fluctuation is not sufficient to cause the cell unit to go out of the normal operating range.

In some embodiments, the preset range and the threshold of the rate of change for determining whether the trigger event of the set type set forth above occurs are adjustable. Optionally, the local controller 130 may receive commands regarding modification or setting of the preset range and the threshold of the rate of change from a device external to the intelligent cell via the communication unit 132.

In some other embodiments, the processing unit 133 reports, via the communication unit 132, various information to the device external to the intelligent cell (e.g., a main controller of the battery module and an information processing device external to the battery module, etc.), including, for example, but not limited to, the occurrence of the trigger event of the set type, the detected input voltage, the output voltage, and the temperature of the cell unit, and the like.

In addition to the various functions and features described above, the processing unit 133 may, for example, in response to a control command from the device external to the intelligent cell, control a discharge rate or a charge rate of the cell unit 110 by adjusting on-off time ratio (duty cycle) of the MOS tube T11 in the internal switch circuit 120.

In some specific implementations, the processing unit 133 may be a processor having digital signal processing capability and/or analog signal processing capability. It is noted that the processor described herein include, but are not limited to, basic units or cores required to perform various computational tasks (the basic units include, for example, an operator, fetch instruction and decoding hardware, an instruction pipeline, interrupt handling hardware, I/O control hardware, and caches, and the like), a set of basic units comprising a plurality of cores, and a System on Chip (SOC), and the like.

In particular, the internal switch circuit and communication unit (e.g., the bus signal transceiver and wireless signal transceiver as described above) are typically hardware circuits that are physically separate from the processing unit, and which may be integrated together in various ways to form a chipset or Chiplet. For example, a die that separately implements the above-described internal switch circuit may be packaged and combined with the processing unit, or a die that separately implements the above-described bus signal transceiver or wireless transceiver function may be packaged and combined with the processing unit, or a die that separately implements the above-described internal switch circuit, a die that separately implements the above-described bus transceiver function, and a die that separately implements the above-described wireless transceiver function may be packaged and combined with the processing unit.

Optionally, the internal switch circuit 120 is provided inside the housing of the aforementioned cell unit 110. Alternatively, the internal switch circuit 120 is provided outside the housing.

### Battery Module

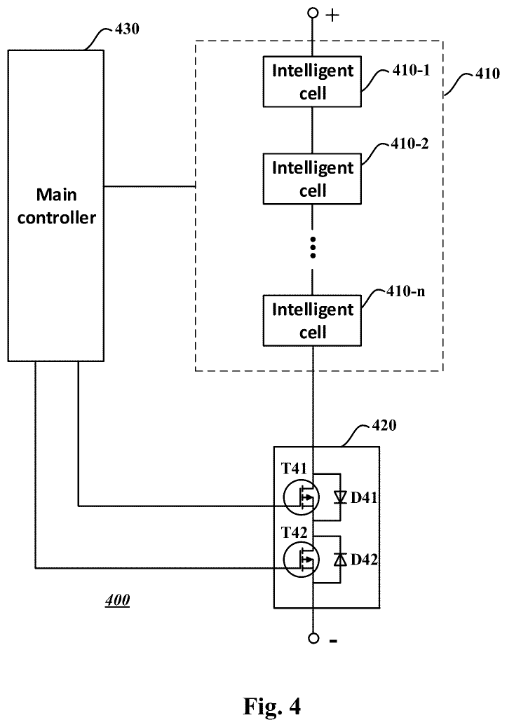

FIG. 4 is a schematic block diagram of a battery module in accordance with some other embodiments of the present application.

A battery module 400 shown in FIG. 4 includes an intelligent cell group 410 comprising a plurality of intelligent cells 410-1, 410-2 . . . 410-n, a main switch circuit 420, and a main controller 430. In the embodiment shown in FIG. 4, each intelligent cell may have the structures, features, and functions of the embodiments described above with reference to FIGS. 1-3, and is therefore only briefly described below in connection with this embodiment.

As shown in FIG. 4, the intelligent cells 410-1, 410-2 . . . 410-n and the main switch circuit 420 are connected together in series, i.e., the cell unit in each intelligent cell together with the main switch circuit are connected in series. The main controller 430 may control the power output and input of the entire battery module by controlling on-off of the main switch circuit 420, thereby realizing the charging and discharging control of the battery module. In addition, the main controller 430 may communicate with the local controller in each intelligent cell (i.e., communicate with the processing unit 133 via the communication unit 132 in the local controller), thereby realizing the charging and discharging control of the individual intelligent cell.

In some embodiments, the main switch circuit comprises two MOS tubes connected in series. Exemplarily, as shown in FIG. 4, the main switch circuit 420 comprises a first MOS tube T41, a second MOS tube T42, a first diode D41, and a second diode D42. Gates of the first MOS tube T41 and the second MOS tube T42 are connected with the main controller 430, a drain (source) of the first MOS tube T41 is connected with a negative electrode of the intelligent cell group 410, a source (drain) is connected with a drain (source) of the second MOS tube T42, a source (drain) of the second MOS tube T42 is connected with a negative electrode of the battery module 400. Positive and negative electrodes of the first diode D41 are connected with the drain (source) and source (drain) of the first MOS tube T41, respectively, and positive and negative electrodes of the second diode D42 are connected with the drain (source) and source (drain) of the second MOS tube T42, respectively. The first MOS tube T41 is also referred to as an input MOS tube because it is connected with the intelligent cell group 410; on the other hand, the second MOS tube T42 is also referred to as an output MOS tube because it is connected with the output of the battery module.

It is to be noted that the MOS tubes T41 and T42 are not limited to the P-channel enhancement type MOS tubes shown in FIG. 4, and the use of other types of MOS tubes is also feasible, such as the P-channel depletion type, the N-channel enhancement type, and the N-channel depletion type.

It is also noted that the main switch circuit 420 may also be connected with a positive electrode of the intelligent cell group 410. At this time, the drain (source) of the first MOS tube T41 is connected with the positive electrode of the battery module 400, the source (drain) is connected with the drain (source) of the second MOS tube T42, and the source (drain) of the second MOS tube T42 is connected with the positive electrode of the intelligent cell group 410.

As described above, the local controller in the intelligent cell may report various information to the main controller via the communication unit, such as including, but not limited to, the occurrence of the trigger event of the set type monitored by the local controller, the input voltage, the output voltage, and the temperature of the cell unit detected by the local controller. Accordingly, the main controller 430 may generate a corresponding control command based on the first state parameter of the cell unit (e.g., the input voltage, the output voltage, and the temperature of the cell unit, etc.) reported by each of the intelligent cells, and send it to the processing unit of the local controller, which may perform corresponding operations based on the control command, such as controlling on-off of the internal switch circuit, or placing the discharge circuits in the enabled-state or disabled-state, etc.; or may control on-off of the main switch circuit 420 (e.g., by controlling the gate voltage of the MOS tubes T41 or T42) based on the first state parameter of the cell unit reported by each of the intelligent cells.

In addition, the main controller 430 may also be equipped with a detection capability for detecting the second state parameter of the battery module 400. The second state parameter described herein may be used to characterize one or more operational states (e.g., an electrical state and a thermal state, etc.) of the battery module. In some embodiments, the second state parameter includes one or more of the following items: an input voltage of the battery module, an output voltage of the battery module, an input current of the battery module, an output current of the battery module, and a temperature of the battery module, etc., In many cases, the state of the intelligent cell group 410 substantially mirrors the state of the battery module 400, and thus the second state parameter of the battery module is equivalent to the second state parameter of the intelligent cell group. Exemplarily, the input voltage and the output voltage may be obtained using a voltage sampling circuit connected with the positive electrode or the negative electrode of the intelligent cell group, the input current and the output current may be obtained using a current sampling circuit connected with the positive electrode or the negative electrode of the intelligent cell group, and the temperature may be obtained using a temperature sensor disposed within or near the intelligent cell group. Accordingly, the main controller 430 may generate a corresponding control command based on the second state parameter of the cell unit of each intelligent cell detected by the main controller 430, and send it to the processing unit of the local controller, which performs a corresponding operation (e.g., placing the internal switch circuit in an on-state or an off-state, and placing the discharge circuit in an enabled-state or a disabled-state, etc.) based on the control command; or may control on-off of the main switch circuit 420 (e.g., by controlling the gate voltage of the MOS tubes T41 or T42) based on the detected second state parameter of the cell unit.

By performing the detection of the state parameters of the cell unit and the battery module by the local controller and the main controller, respectively, redundancy in the monitoring of the operational states may be provided, thereby improving the reliability of the battery management. For example, even if a detection failure occurs at the local controller, as long as the detection function at the main controller is functioning properly, an operating abnormality of the battery module can still be detected in a timely manner, and vice versa. In addition, when the judgment of the operational states based on the first state parameter and the second state parameter does not match, the judgment result may be selected according to pre-set rules and corresponding processing logic may be executed. Exemplarily, the rule may be set such that the confidence level of the judgment result based on the second state parameter is higher than the confidence level of the judgment result based on the first state parameter; or vice versa.

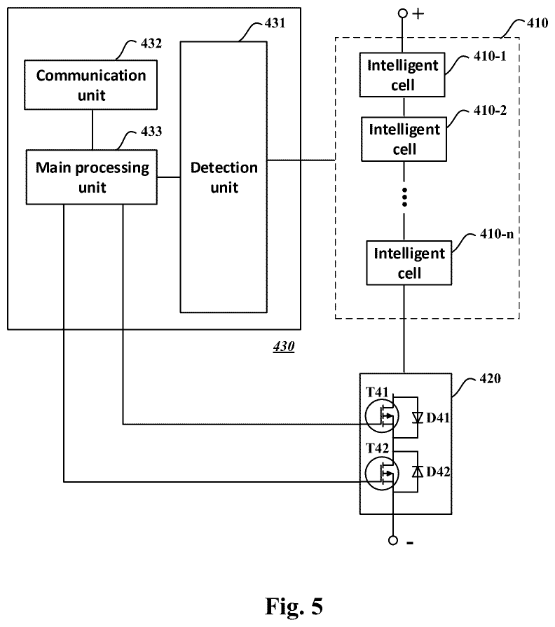

FIG. 5 is a schematic block diagram of a main controller that may be used as a main controller in the battery module shown in FIG. 4, in accordance with some other embodiments of the present application.

In the main controller shown in FIG. 5, each box corresponds to a corresponding logic function module. It is noted that in specific implementations, various ways may be used to realize the logic function of each module. For example, one or more logic function modules may be implemented by a single hardware circuit, or one or more logic function modules may be implemented by multiple hardware circuits in concert. In some embodiments, the hardware circuit may be implemented in the form of a die, and optionally, multiple hardware circuits in the form of the die are packaged and combined together to form a Chiplet.

Referring to FIG. 5, the main controller 430 includes a detection unit 431, a communication unit 432, and a main processing unit 433. The above components will be further described below.

The detection unit 431 is configured to detect the second state parameter of the cell unit in the intelligent cell. The communication unit 432 is a communication interface of the main controller, which is configured to establish a wireless or wired communication connection with the intelligent cell; in addition, the communication unit 432 is configured to establish a wireless or wired communication connection with a device external to the battery module 40 (e.g., an information processing device such as a smartphone, a laptop, a tablet, and a desktop computer, among others). Optionally, the communication unit 432 may be a wireless signal transceiver (e.g., a Bluetooth communication device or a near field communication device). Alternatively, the communication unit may be a bus signal transceiver (e.g., a single bus signal transceiver).

Referring to FIG. 5, the main processing unit 433 is coupled to the main switch circuit 320, the detection unit 431 and the communication unit 432, which are configured to perform various operations. In some embodiments, the operations include, for example:

generating a corresponding control command based on the first state parameter about the cell unit reported by the local controller of the intelligent cell, and sending the generated control command to the local controller to control on-off of the internal switch circuit in the intelligent cell, or to place the discharge circuit in the intelligent cell in an enabled-state or a disabled-state;
controlling on-off of the main switch circuit 420 (e.g., by controlling a gate voltage of a MOS tube in the main switch circuit) based on the first state parameter about the cell unit reported by the local controller of the intelligent cell;
generating a corresponding control command based on the second state parameter of the respective cell unit obtained by the detection unit 431, and sending the generated control command to the corresponding local controller to control on-off of the internal switch circuit in the intelligent cell, or to place the discharge circuit in the intelligent cell in an enabled-state or a disabled-state;
controlling on-off of the main switch circuit 420 based on the second state parameter of the respective cell unit obtained by the detection unit 431.

In particular, the main processing unit 433 may realize the above operations by responding to a trigger event of a set type associated with a change in the second state parameter. That is, when the trigger event of the set type occurs, the main switch circuit 420 is placed in an on-state or an off-state. In some embodiments, the trigger event of the set type may include one or more of the following items:
2a) at least one of the second state parameter exceeds a corresponding preset range.
2b) a rate of change of at least one of the second state parameter exceeds a corresponding threshold.
2c) at least one of the second state parameter returns to the preset range from outside the corresponding preset range. It should be noted that for the same type of state parameter, the preset ranges of the trigger condition for type 2a) and the trigger condition for type 2c) may or may not be the same.
2d) a rate of change of at least one of the second state parameter drops from exceeding the corresponding threshold to below the threshold. It should be noted that for the same type of state parameter, the thresholds of the rate of change for the trigger events of types 2b) and 2d) may or may not be the same.

As described above, the preset range of the state parameter may be used to judge a trending change in the state of the cell unit, while the threshold of the rate of change of the state parameter may be used to judge a transient fluctuation of the state of the cell unit.

As described above, when the judgment of the operational states based on the first state parameter and the second state parameter does not match, the corresponding judgment result may be selected according to pre-set rules and corresponding processing logic may be executed accordingly (e.g., placing the internal switch circuit in an on-state or an off-state, placing the main switch circuit in an on-state or an off-state, and placing the discharge circuit in an enabled-state or a disabled-state, etc.).

In some embodiments, the main processing unit 433 may send an adjustment command to the local controller, and accordingly, the local controller adjusts the preset range and the threshold of the rate of change for the trigger events of types 1a)-1d) based on the adjustment command.

In still other embodiments, the main processing unit 433 may be configured to determine a SOC value of the cell unit in each intelligent cell and generate a charge/discharge rate adjustment command based on the determined SOC value, and accordingly, the local controller, in response to the charge/discharge rate adjustment command, controls a discharge rate or a charge rate of the cell unit by adjusting on-off time ratio (duty cycle) of the MOS tube in the internal switch circuit, thereby realizing charging equalization and discharging equalization among the plurality of cell units.

In some specific implementations, the main processing unit 433 may be a processor having digital signal processing capability and/or analog signal processing capability. It is noted that the processor described herein include, but are not limited to, basic units or cores required to perform various computational tasks (the basic units include, for example, an operator, fetch instruction and decoding hardware, an instruction pipeline, interrupt handling hardware, I/O control hardware, and caches, and the like), a set of basic units comprising a plurality of cores, and a System on Chip (SOC), and the like.

In particular, the main switch circuit and communication unit (e.g., the bus signal transceiver and wireless signal transceiver as described above) are typically hardware circuits that are physically separate from the processing unit, and which may be integrated together in various ways to form a small chip. For example, a die that separately implements the above-described main switch circuit may be packaged and combined with the main processing unit, or a die that separately implements the above-described bus signal transceiver or wireless transceiver function may be packaged and combined with the main processing unit, or a die that separately implements the above-described main switch circuit, a die that separately implements the above-described bus transceiver function, and a die that separately implements the above-described wireless transceiver function may be packaged and combined with the main processing unit.

### Battery Pack

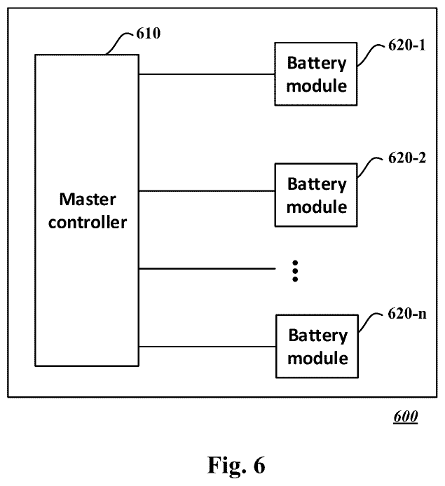

FIG. 6 is a schematic diagram of a battery pack in accordance with some other embodiments of the present application.

A battery pack 600 shown in FIG. 6 comprises at least one master controller 610 and a plurality of battery modules 620-1, 620-2 . . . 620-n, wherein the plurality of battery modules 620-1, 620-2 . . . 620-n may be connected together in series, parallel, or mixed.

In the embodiment shown in FIG. 6, each battery module may have the structures, features, and functions of the embodiments described above with reference to FIGS. 1-5, which are not repeated herein.

In some embodiments, both the master controller 610 and the main controller in each battery module may have access to a communication bus 630 to enable communication between the master controller and the main controller and between the main controllers.

In some other embodiments, communication between the master controller 610 and the main controllers of the battery modules, and between the main controllers of the individual battery modules, may be wirelessly realized between each other.

Those skilled in the art will appreciate that various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will appreciate that the present application may be embodied in many other forms without departing from the spirit and scope thereof. Accordingly, the examples and implementations shown are to be regarded as illustrative and not restrictive, and various modifications and substitutions may be covered by the present application without departing from the spirit and scope of the present application as defined by the appended claims.

What is claimed is:

1. An intelligent cell comprising:
a cell unit;
an internal switch circuit coupled to a positive electrode or negative electrode of the cell unit; and
a local controller comprising:
an internal detection unit configured to detect a state parameter of the cell unit, the state parameter comprising at least one of an input voltage, an output voltage, and a temperature;
a communication unit configured to establish a communication connection with a device external to the intelligent cell; and
a processing unit coupled to the internal switch circuit, the internal detection unit and the communication unit, configured to control on-off of the internal switch circuit based on the state parameter or in response to a control command received by the communication unit.

2. The intelligent cell of claim 1, wherein the internal switch circuit comprises a single MOS tube, and the processing unit places the internal switch circuit in an on-state or an off-state by controlling on-off of the single MOS tube.

3. The intelligent cell of claim 1, wherein further comprising a discharge circuit coupled to the cell unit, and the processing unit is further configured to place the discharge circuit in an enabled-state or a disabled-state based on the state parameter or in response to a control command received by the communication unit.

4. The intelligent cell of claim 3, wherein the communication unit is a wireless signal transceiver or a bus signal transceiver.

5. The intelligent cell of claim 3, wherein the processing unit is further configured to report, via the communication unit, to the device external to the intelligent cell, at least one of the following items: an occurrence of a trigger event of a set type, the input voltage, the output voltage and the temperature of the cell unit as detected.

6. The intelligent cell of claim 5, wherein the processing unit is configured to control the on-off of the internal switch circuit or to place the discharge circuit in the enabled-state or the disabled-state based on the state parameter by responding to the trigger event of the set type.

7. The intelligent cell of claim 5, wherein the trigger event of the set type comprises one or more of: 1a) at least one of the state parameter exceeding a corresponding preset range; 1b) a rate of change of at least one of the state parameter exceeding a corresponding threshold; 1c) at least one of the state parameter returning to the preset range from outside the corresponding preset range; 1d) a rate of change of at least one of the state parameter dropping from exceeding the corresponding threshold to below the threshold.

8. The intelligent cell of claim 7, wherein the local controller is further configured to modify settings regarding the preset range and the threshold based on a configuration command from the device external to the intelligent cell.

9. A battery module comprising:
a main controller;
a plurality of intelligent cells, each intelligent cell comprising:
a cell unit;
an internal switch circuit coupled to a positive electrode or negative electrode of the cell unit; and
a local controller comprising:
an internal detection unit configured to detect a first state parameter of the cell unit, the first state parameter comprising at least one of an input voltage, an output voltage, and a temperature of the cell unit;
a first communication unit configured to establish a communication connection with the main controller or a device external to the battery module; and
a processing unit coupled to the internal switch circuit, the internal detection unit and the first communication unit, configured to control on-off of the internal switch circuit based on the first state parameter or in response to a control command received by the first communication unit;
a main switch circuit coupled in series with the cell units of the plurality of intelligent cells;
wherein the main controller comprising:
a detection unit configured to detect a second state parameter of the battery module, the second state parameter comprising at least one of an input voltage, an output voltage, an input current, an output current, and a temperature of the battery module;
a second communication unit configured to establish a communication connection with the first communication unit in each intelligent cell;
a main processing unit coupled to the detection unit, the second communication unit and the main switch circuit, configured to: i) generate the control command or control on-off of the main switch circuit based on the first state parameter of the cell unit reported by each intelligent cell; and ii) generate the control command or control on-off of the main switch circuit based on the second state parameter of the battery module.

10. A battery pack comprising:
a battery module as claimed in claim 9;
at least one master controller communicatively coupled to a main controller in each battery module.
